(19) United States
(12) Patent Application Publication
(10) Pub. No.: US 2006/0274551 A1
(43) Pub. Date: Dec. 7, 2006

(54) Surface light source device and display

(75) Inventor: Susumu Takada, Tokyo (JP)

Correspondence Address: STAAS & HALSEY LLP, SUITE 700, 1201 NEW YORK AVENUE, N.W., WASHINGTON, DC, 20005, US

(73) Assignee: ENPLAS CORPORATION, Kawaguchi-shi (JP)

(21) Appl. No.: 11/440,018

(22) Filed: May 25, 2006

(30) Foreign Application Priority Data
May 26, 2005 (JP) 153429 / 2005

(51) Int. Cl. F21V 7/04

(52) U.S. Cl. 362/611

(57) ABSTRACT

Emission of a surface light source device is prevented from having brightness-unevenness, having a uniformalized brightness. A plurality of LEDs are disposed opposite to an incidence face of a light guide plate. A reflection sheet is disposed along a back face of the light guide plate while a cover member for the LEDs is disposed on an emission face in the vicinity incidence face. A light diffusion member, first and second light control members are laminated disposed along a part of the emission face which is not covered by the cover member. A top of the reflection sheet is secluded a predetermined distance L from the incidence face to provided a part which is not covered by the reflection sheet in the vicinity of the incidence face. The predetermined distance L may be given, for example, by L=2h·tan θ (where h=thickness of light guide plate at incidence face, θ=critical angle at an interface between light guide plate and air.

### BACKGROUND

1. Technical Field

The present invention relates to a surface light source device and a display such as liquid crystal display employing the same for illuminating a display member, for example, a liquid crystal display panel.

2. Related Art

It is known well to employ a surface light source device for uses such as backlighting in LCD. In general, a surface light source device has a light guide plate and a primary light source for supplying light to the light guide plate. LED (Light Emitting Diode), a point-like light source, has been frequently employed as primary light source. Usually, LED is disposed in the vicinity of a side face (incidence face) of a light guide plate. Light (primary light) from LED enters into the light guide plate, becoming inner propagation light. This inner propagation light is emitted from an emission face gradually on the way of inner propagation to illuminate a display member such as LCD panel.

FIG. 11 illustrates an example of surface light source device of the above-described type (first prior art), being disclosed in Document 1 noted below. Referring to FIG. 11, surface light source device 1 has light guide plate 10 having emission face 13 along which light diffusion member 6 and prism sheets 4, 5 are disposed laminatedly. Reflection sheet 12 is disposed along back face 14.

As known well, emission from emission face 13 is gathered around of a normal direction of emission face 13 by prism sheets, 4, 5 after being diffused by light diffusion member 6. This causes display member (such as LCD panel) 3 disposed opposite to emission face 13 to be illuminated effectively.

Reference numeral 8 denotes a driving circuit board for LED 7, extending from above LED 7 to above the vicinity of incidence face 11. That is, a top portion of driving circuit board 8 gives a cover above a part of emission face 13. A reflection member (such as silver sheet) is applied to driving circuit board 8 as to correspond to the part.

Light incident to the reflection member is returned into light guide plate 10. Needless to say, light leaked from back face 14 is, after being reflected by reflection member 12, also returned into light guide plate 10.

FIG. 12 illustrates another prior art (second prior art), being disclosed in Document 2 noted below. Referring to FIG. 12, surface light source device 10 has employs a line-like light source 100 as primary light source instead of LED as primary light source. Line-like light source 100 is surrounded by light reflector 102. Light from line-like light source 100 is reflected by reflector 102, being incident to incidence face (a side end face) 104 of light guide plate 103.

Light diffusion member 106 and light control member (prism sheet) 108 are disposed along emission face 105 of light guide plate 103. Light control member 108 is provided with many prismatic projections 107 running in a direction parallel with incidence face 104. Light from line-like light source 100 enters into light guide plate 103 through incidence face 104 thereof, becoming inner propagation light. This inner propagation light is emitted from emission face 105 gradually on the way of inner propagation.

Emission is gathered around of a normal direction of emission face 105 by light control member 8 after being diffused by light diffusion member 106. This provides an increased emission brightness for the normal direction of emission face 105.
Document 1; Tokkai-2002-229022(JP)
Document 2; Tokkyo-3500726(JP)

However, the first prior art (FIG. 11) shows a tendency that light reflected by driving circuit board 8 enters into light guide plate 10 from the vicinity of an edge (upper edge 17) at which incidence face 11 meets emission face 13, since driving circuit board 8 extends up to above the vicinity of incidence face 11 while reflection sheet 12 is disposed along back face 14. In addition, light reflected by reflection sheet 12 is apt to enter into light guide plate 10 from the vicinity of an edge (lower edge 18) at which incidence face 11 meets back face 14.

Much of the light introduced into light guide plate 10 from in the vicinities of the upper and lower edges 17, 18 outgoes from emission face 13 around incidence face 11.

This is, as a result, brings bright part 20 which looks like an ellipse as viewed from a frontal direction of emission face 13 (See FIGS. 8a, 8b).

In addition, an observer will catch similar bright part 20 or band-like bight region 21 as viewed from a direction inclined with respect to the normal direction of emission face 13 (See FIGS. 8c, 8d). Needless to say, such bright part 20 or band-like bright region 21 gives a locally excessive brightness, being not desirable.

On the other hand, the second prior art brings band-like bright line(s) parallel with incidence face 104 because light introduced into light guide plate 103 from upper and lower edge portions 110, 111 of incidence face 104 outgoes from emission face 105 in accordance with incidence face 104. Prismatic projections 107 of light control member 108 tend to cause such a bright line (or lines) to be more conspicuous.

To avoid this, a line-like light source side edge of light control member 108 is shifted with respect to that of light diffusion member 106 as to be remote from line-like light source 100 by predetermined distance Lx (for example, not less than 1.5 mm or, preferably, not less than 2.0 mm).

However, such shifting can fail to prevent enough bright line(s) from appearing depending on plate-thickness of light guide plate 103. Above all, if the above sifting (FIG. 12) is applied to as case where a point-like light source like LED is employed as primary light source instead of line-like light source 100, it can be difficult to prevents enough any bright part or band-like bright region from appearing depending on depending on plate-thickness of light guide plate 103.

### OBJECT AND SUMMARY OF INVENTION

An object of the present invention is to prevent a surface light source device employing a point-like light source such as LED as a primary light source from appearing a locally excessively bright part on an emission face to provide a uniformalized emission brightness.

Another object of the present invention is to provide a display capable of providing a high-quality display by employing the improved surface light source device.

First, the present invention is applied to a surface light source device comprising a primary, light source consisting of at least one point-like light source, a light guide plate 10 having a side face providing an incidence face to receive primary light from said primary light source and an emission face including effective light emitting area from which light is outputted as illumination light, and a back face opposite to said emission face and a reflection member which is provided with a reflection face having a high light reflectivity and is disposed so that said reflection face is directed to said back face.

According to a basic feature of the present invention, said back face includes a first area opposite to which said reflection member is disposed and a second area opposite to which said reflection member is not disposed, and further

said back face provides, at least at a location corresponding to a disposal location of said primary light source and within a range of a first predetermined distance from said incidence face, a region belonging to said second area.

It is preferable that said first predetermined distance is generally equal to 2h·tan θ (where h is thickness of said light guide plate at said incidence face and angle θ is critical angle at an interface between said light guide plate and air).

Said back face may not include, within said range of said first predetermined distance, any part belonging to said first area.

Alternatively, said back face may includes, within said range of said first predetermined distance, a first part belonging to said first area and a second part belonging to said second area, said second part being a part corresponding to said disposal location of said primary light source.

It is preferable that said effective light emitting area extends only in ma range exceeding a second predetermined distance from said incidence face, said second predetermined distance is slightly larger than said first predetermined distance.

Said reflection member may be provided with at least one elongation which is elongated away from said incidence face over an imaginary line dawn by extending an light outgoing surface of said point-like light source in parallel with said incidence face.

In every above case, a member which has a surface light reflectivity of which is lower than that of said reflection face may be disposed so that said surface is opposite to said second area of said back face.

Alternatively, a light shielding member having a light absorptive surface may be disposed so that said light absorptive surface is opposite to said second area of said back face.

The present invention is also applied to a display comprising a surface light source device and a display member illuminated by said A surface light source device. According to the present invention, any of the above surface light sources is employed in the display.

As described in the embodiment in details, a surface light source device in accordance with the present invention avoids an emission face thereof from showing an excessively bright part and gives a uniformalized emission brightness. In addition a display can provide a high quality display by employing thus improved surface light source device.

### BRIEF DESCRIPTION OF DRAWINGS

FIG. 1 is an exploded perspective diagramic view of a surface light source device and a display provided with the same in accordance with a first embodiment of the present invention;

FIG. 2 is a plan view of the surface light source device and the display shown in FIG. 1;

FIG. 3 is a cross section view along line A-A in FIG. 1;

FIG. 4 is a back plan view of the surface light source device and the display shown in FIG. 1;

FIG. 5 is an enlarged side view for illustrating an end portion at an incidence face of a light guide plate employed in the first embodiment;

FIG. 6a is at side view for showing an observing direction corresponding to an illustration of FIG. 6b;

FIG. 6b is a diagramic plan view for illustrating emission, as observed from a normal direction of an emission face of the light guide plate employed in the first embodiment;

FIG. 6c is a side view for showing an observing direction corresponding to an illustration of FIG. 6d;

FIG. 6d is a diagramic plan view for illustrating emission, as observed from a direction inclined with respect to the normal direction of the emission face of the light guide plate employed in the first embodiment;

FIG. 7 is a side view of a conventional surface light source device and a display provided with the same, including an enlarged side view for illustrating an end portion at an incidence face of a light guide plate;

FIG. 8a is a side view for showing an observing direction corresponding to an illustration of FIG. 8b;

FIG. 8b is a plan view for illustrating emission, as observed from a normal direction of an emission face of a light guide plate employed in the conventional surface light source device shown in FIG. 7;

FIG. 8c is a side view for showing an observing direction corresponding to an illustration of FIG. 8d;

FIG. 8d is a diagramic plan view for illustrating emission, as observed from a direction inclined with respect to the normal direction of the emission face of the light guide plate employed in the conventional surface light source device shown in FIG. 7;

FIG. 9 is a back plan view of a surface light source device and the display provided with the same in accordance with a second embodiment of the present invention;

FIG. 10 is a side-viewing cross section for illustrating a surface light source device ad the display provided with the same in accordance with a modification of the present invention;

FIG. 11 is an exploded perspective diagramic view of a surface light source device and a display provided with the same in accordance with a first prior art; and,

FIG. 12 is a side view of a surface light source device in accordance with a second prior art, including an enlarged side view for illustrating an end portion at an incidence face of a light guide plate.

### EMBODIMENTS

### First Embodiment

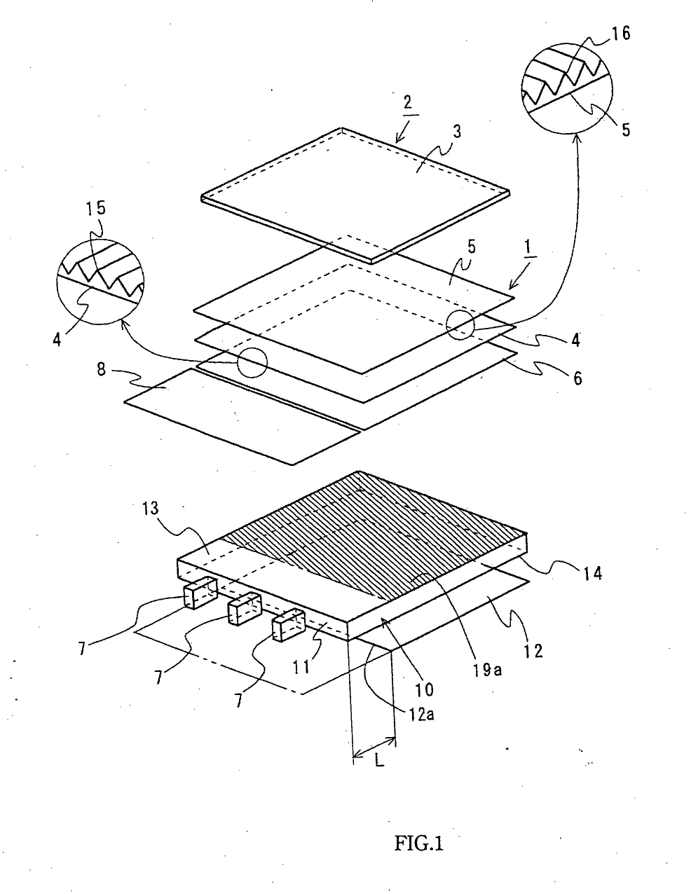

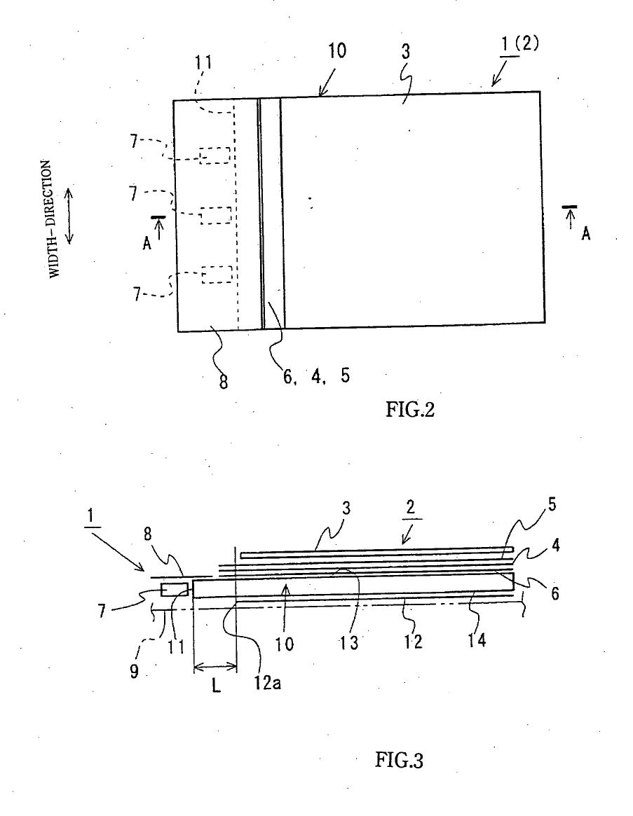

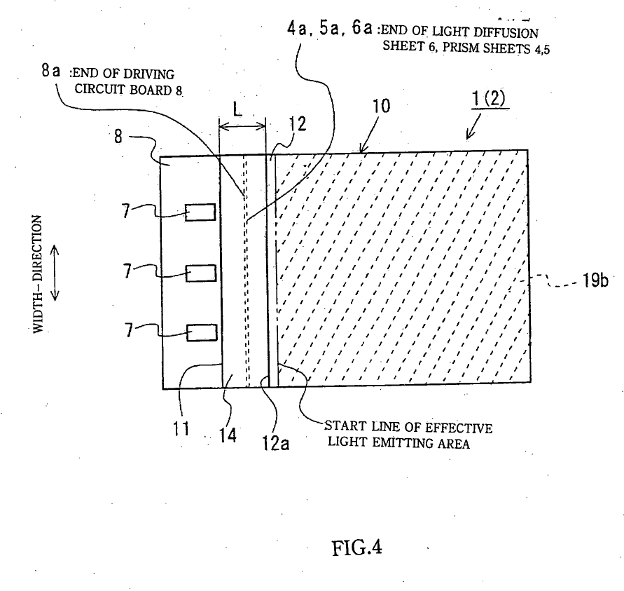

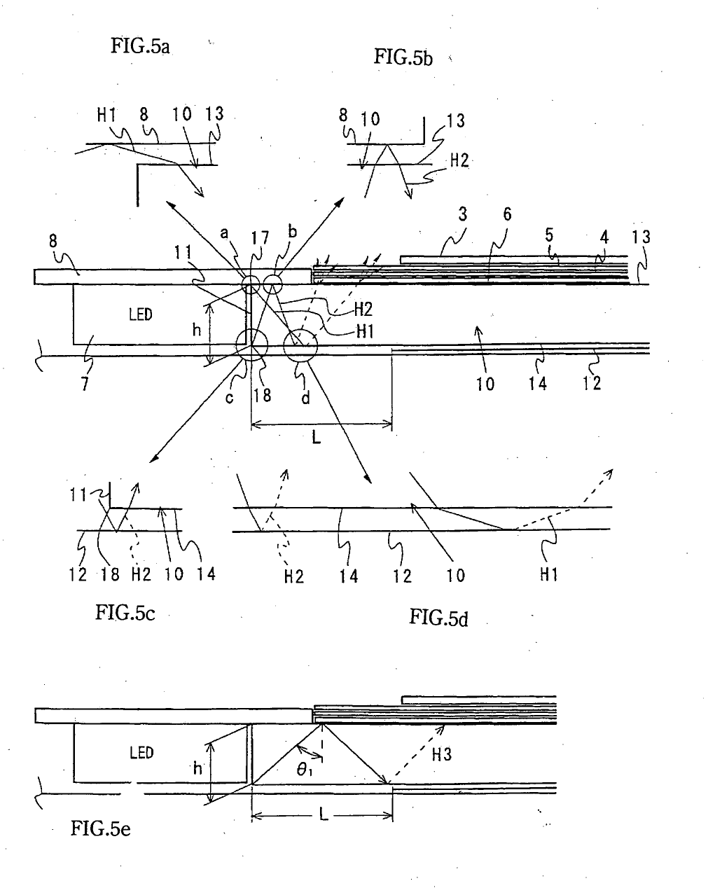

Surface light source device 1 and display 2 provided with the same are shown in FIGS. 1 to 5. FIG. 1 is an exploded perspective diagramic view of display 2 and FIG. 2 is a plan view of display 2. FIG. 3 is a side view of display 2 and FIG. 4 is a back plan view of display 2. FIG. 5 is an enlarged side view for illustrating incidence face (side face) 11 of light guide plate 10 and vicinage thereof.

As shown in these illusions, surface light source device 1 is composed of reflection sheet (reflection member) 12, and light guide plate 10, light diffusion member 6, first and second light control members 4, 5 mounted on reflection sheet 12 laminatedly, and a plurality of LEDs (point-like light sources) 7 disposed opposite to incidence face 11 of light guide plate 10.

Reference numeral 8 denotes a driving circuit board functioning as a cover member, which extends from above LEDs 7 to above emission face 13 in the vicinity of incidence face 11.

Image display panel (display member) 3 is disposed laminatedly on the outside of second light control member 5. Display 2 is composed of surface light source device 1 and image display panel 3. Image display panel 3 is irradiated by illumination light outputted from surface light source device 1. As described later, light used for irradiating display panel (display member) 3 is that emitted from a part (an area covering emission face 13 except for non-effective light emitting area extending along a periphery edge) of emission face 13, of light guide plate 10.

Light guide plate 10 is a thin plate-like member, being made of a light permeable material such as, PMMA (polymethyl methacrylate), PC (polycarbonate) or cycloolefin-type resin (See FIG. 1). Light guide plate 10 has a generally rectangular plan shape (See FIG. 2.). In addition, light guide plate 10 has a rectangle-like cross section along a plane which is perpendicular to both incidence face 11 and emission face 13. Light guide plate 10 has a constant plate-thinness uniform overall.

It can be said that emission face 13 is provided by a major face of light guide plate 10 and incidence face 11 is provided by a minor face (side face) of light guide plate 10. The other major face located opposite to emission face 13 provides back face 14. Back face 14 provided with many micro-unevennesses which diffuse and redirect light propagating within light guide plate 10 toward emission face 13.

A plurality of LEDs (point-like light sources) 7 are disposed opposite to incidence face 11. Light guide plate 10 may have a cross section shape other than rectangle. For example, allowable is a wedge-like cross section such that thickness decreases gradually away from incidence face 11.

Back face 14 may be provided with prismatic grooves running in a direction generally perpendicular to the incidence face instead of unevennesses or together with them. Alternatively, light guide plate 10 may contain light scattering material inside, instead of or in addition to unevennesses on a back face 14. Further, back face 14 may avoid intentionally from being roughened.

As shown in FIGS. 1 and 2, LEDs 7 are arranged at a generally constant interval, and light from each LED enters into light guide plate 10 through incidence face 11, becoming inner propagation light. This inner propagation light is emitted from an emission face 13 gradually on the way of inner propagation. It is noted that emission face 13 meets incidence face 11 at upper edge 17. Emission face 13 extends in a plane generally perpendicular to incidence face 11.

Effective light emitting area (hatched area in FIG. 1) 19a is set in emission face 13. Effective light emitting area 19a is set as to correspond to an image displaying area of image display panel 3, being required to have a generally uniform emission brightness overall.

It is noted that area 19b on back face 14, which is denoted by dotted-line-hatched in FIG. 4, corresponds to effective light emitting area 19a on emission face 13. In other words, area 19b has the same size and shape as those of effective light emitting area 19a and both areas 19a, 19b align with each other along a plate-thickness direction.

As shown in FIGS. 1 and 3 to 5, white reflection sheet (reflection member) 12 is disposed opposite to a “first area on back face 14 (lower face in FIG. 3). For the sake of convenience, “a first area” is defined as a part of back face 14 which is opposite to reflection sheet 12. The other part is called “second area” opposite to which no reflection sheet 12 exists.

Reflection sheet 12 is provided with an inner surface having a high light reflectivity (for example, 70% or more), being made of a resin material such as PET (polyethylene terephthalate). The inner surface of reflection sheet 12 is opposite to “first area.” of back face 14. Refection sheet 12 functions as to reflect light leaked from back face 14 to return the leaked light into light guide plate 10. It is noted that reflection sheet 12 may be a member such as silver sheet or mirror-surface member or the like instead of resin sheet made of resin material such as PET.

Reflection sheet 12 is shaped like a rectangle, a top of which is near to LEDs 7 and located as to be shifted from incidence face 11 by predetermined distance L. That is, back face 14 is not covered by reflection sheet 12 except for the foresaid “first area”.

In other words, “first area” in this embodiment exists only in a range over predetermined distance L from incidence face 11. In still other words, reflection sheet 12 has a shape like one gotten by cutting off a band-like part of width equal, to predetermined distance L along a length-direction of incidence face 12 from a rectangle having the same size and shape as those of back face 14.

It is preferable that predetermined distance L is equal or generally equal (for example, difference of ±5%) to 2h·tan θ. Here, h is thickness of light guide plate 10 at incidence face 11 and angle θ is critical angle at an interface between light guide plate 10 and air (refractive index=about 1.0).

Thus predetermined distance L is set under consideration of a position at which light H3 is inner-reflected by back face 14 for the first time, wherein light H3 is light that is easily emitted from emission face 13 in the vicinity of incidence face 11 after entering into light guide plate 10 from a vicinage of intersection between incidence face 11 and back face 13 (See FIG. 5(e).

It can be said that this light H3 is light that gives the maximum incidence angle to incidence face 11 and makes inner-incidence angle θ1 to emission face 13 the minimum. Attention should be paid to a fact that the smaller inner-incidence angle θ1 is the easier emission from emission face 13 occurs.

If predetermined distance L is set as above, position of top 12a of reflection sheet 12 is shifted from an end, which is near to the incidence face, of foresaid ares 19b by a very small distance, (for example, not less than 0.5 mm and not greater than 2 mm) toward incidence face 11. This prevents top 12a of reflection sheet 12 from being observed from above emission face 13.

Formed is an area that is a part of back face and not covered by reflection sheet 12, namely, an area opposite to which no reflection sheet 12 exists, in the vicinity of incidence face 11.

As shown in FIG. 3, what is opposite to this area is an inner surface of a frame 9 accommodating reflection sheet 12, light guide plate 10 and others. The inner surface does not have a high light reflectivity but has a light reflectivity (for example, 50% or less) at least lower than that of an inner surface (reflection surface) of reflection sheet 12.

Thus, for example, if reflection sheet 12 is formed of a sheet to which silver is vapour-evaporated, employed is a frame formed of resin such as PC or ABS, or metal such as stainless steel or plated-steel.

Alternatively, surface processing for giving a low light reflectivity (such as light-shielding print) may be applied to the inner surface of frame 6.

On the other hand, driving circuit board 8 for LEDs 7 is disposed on the side of emission face 13 and at a vicinage of incidence-face 11 as shown in FIGS. 1 to 5. Driving circuit board 8 has an inner surface which is opposite to emission face 13 and provided with a light reflectivity. Therefore, when light emitted from emission face 13 impinges on this inner surface, the light is reflected and returned into light guide plate 10.

The inner surface of driving circuit board 8 may be a white reflection surface (diffusive reflection surface), grey reflection surface (light absorptive reflection surface) or silver-colored reflection surface (mirror refection surface). Driving circuit board 8 can function as a kind of cover member.

In addition, driving circuit board 8 may be unified with reflection sheet 12. Further, driving circuit board 8 may be disposed as to contact with emission face 13, or, alternatively may be fixed to emission face 13 by an adhesive tape.

As shown in FIGS. 1 to 5, some part of emission face 13 remains a part on which driving circuit board 8 as a cover member is not arranged and sheet-like light diffusion member 6 is arranged laminatedly.

Light diffusion member 6 is made of well-light-permeable material (such as PET), transmitting and diffusing light emitted form emission face 13 randomly. An end near to LEDs 7 of light diffusion member 6 is located as to be adjacent to driving circuit board 8.

According to a modification, however, the end near to LEDs 7 of light diffusion member 6 is arranged as to extent onto driving circuit board 8. Alternatively, the end near to LEDs 7 of light diffusion member 6 may be located between driving circuit board 8 and first and second light control members 4, 5.

Further alternatively, the end near to LEDs 7 of light diffusion member 6 may accord with ends near to LEDs 7 of first and second light control members 4, 5.

As shown in FIGS. 1 to 5, first and second light control members 4, 5 are disposed on the outside (upper side) of light diffusion member 6 laminatedly. Light control members 4, 5 are made of well-light-permeable material (such as PET), having a rectangle—@:like plan shape.

First light control member 4 has an outer surface (light outputting side) provided with many prismatic projections 15 running in a direction generally perpendicular to incidence face 11. Each prismatic projection 15 has a triangle-like cross section with apex angel of approximately 90°.

On the other hand, second light control member 5 has an outer surface (light outputting side) provided with many prismatic projections 16 each having a cross section like that of prismatic projection 15. Second prismatic projections 16 run in a direction generally perpendicular to the running direction of prismatic projections 15 (See FIG. 1).

### Effects of the Embodiment

Light emitted from LEDs 7 (primary light) enters into light guide late 10 through incidence face 11. It should the noted that some light enters into light guide plate 10 via a vicinage of upper or lower edge 17, 18 as shown by beam H1, H2 (See FIG. 5a).

Since beams H1, H2 has incidence angles to emission face 13 which are smaller than those of light entering into light guide plate 10 through incidence face 11 as shown in FIG. 5a, beams H1, H2 are apt to escape easily from emission face 13 or back face 14 in the vicinity of incidence face 11. Much of light escaped from emission face 13 in the vicinity of incidence face 11 is reflected cover member 8 of LEDs 7 and returned into light guide plate 10.

On the other hand, much of light escaped from back face 14 in the vicinity of incidence face 11 is incident to the inner surface of frame 9. Remarkable portion of the incident light is absorbed and not reflected because the inner surface of frame 9 does not have a high light reflectivity as described previously. Light reflected by the inner surface of frame 9 is returned into light guide plate 10. However, this returning light is relatively weak.

Provided that top 12a of reflection sheet 12 extends as to reach incidence face 11, returning light would be increased. Increased returning light would cause emission face 13 to have a locally abnormal emission (excessive brightness) in the vicinity of incidence face 11. This embodiment is, free from such abnormal emission (excessive brightness). It is noted that much of light leaked from back face 14 in a range over predetermined distance L from incidence face 11 is reflected by reflection sheet 12 and returned into light guide plate 10 to be utilized for illumination effectively.

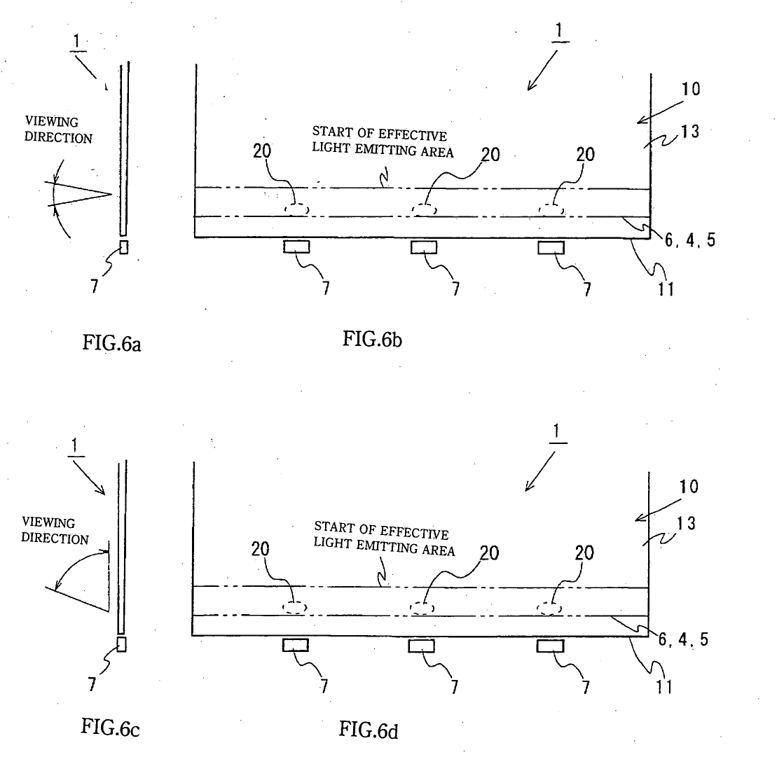

Light emitted from effective light emitting area 19a is diffused randomly by light diffusion member 6 and then gathered around a normal direction of emission face 13 by first and second light control members 4,5. As a result, when viewed from the normal direction of emission face 13, ellipse-like bright part 20 is made less conspicuous, as shown in FIGS. 6a, 6b, leading to a relaxed bright-dark difference of emission.

Further, when viewed from a direction inclined with respect to the normal direction of emission face 13, ellipse-like bright part 20 is made less conspicuous, as shown in FIGS. 6c, 6d, and band-like bright region 21, as shown in FIG. 6d, is removed. Thus bright-dark difference of emission is relaxed.

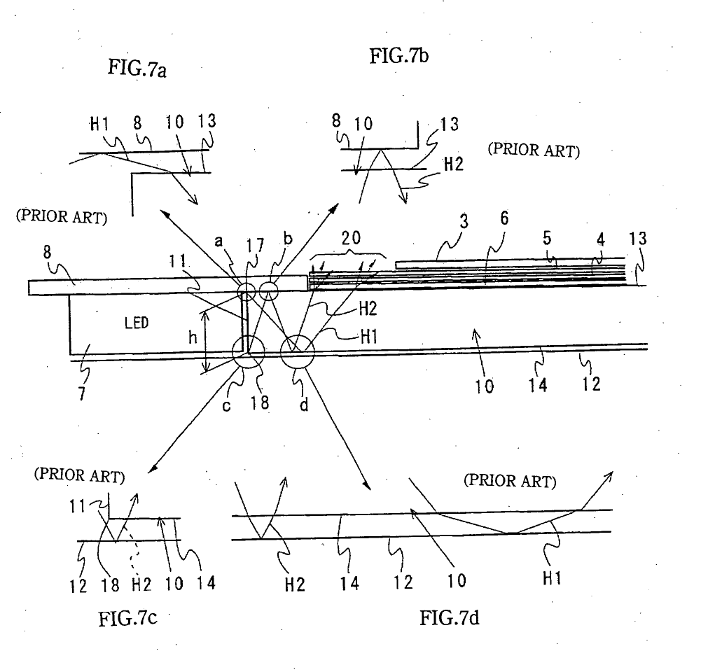

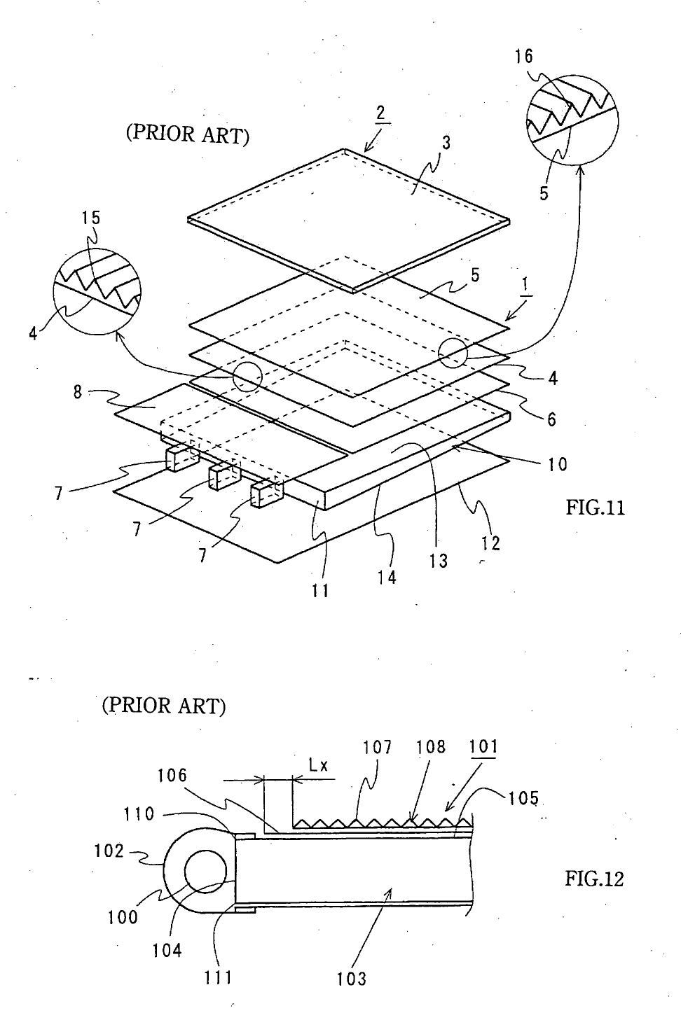

To the contrary, according to a prior art as shown in FIG. 7, back face 14 is covered by reflection, sheet 12 in the vicinity of incidence face 11. Accordingly, light H1, H2 entering into, light guide plate 10 via vicinages of upper/lower edges 17, 18 is reflected by reflection sheet 12 and returned into light guide plate 10. As a result, As shown in FIG. 7, light H1, H2 entering via vicinages of upper/lower edges 17, 18 is emitted from emission face 13 in the vicinity of incidence face 11. Specifically saying, this light is redirected to the normal direction of emission face 13 by prismatic projections 16 of second light control member 5 running in a direction generally perpendicular to a travelling direction (perpendicular to incidence face 11) of light H1, H2 (See FIG. 11).

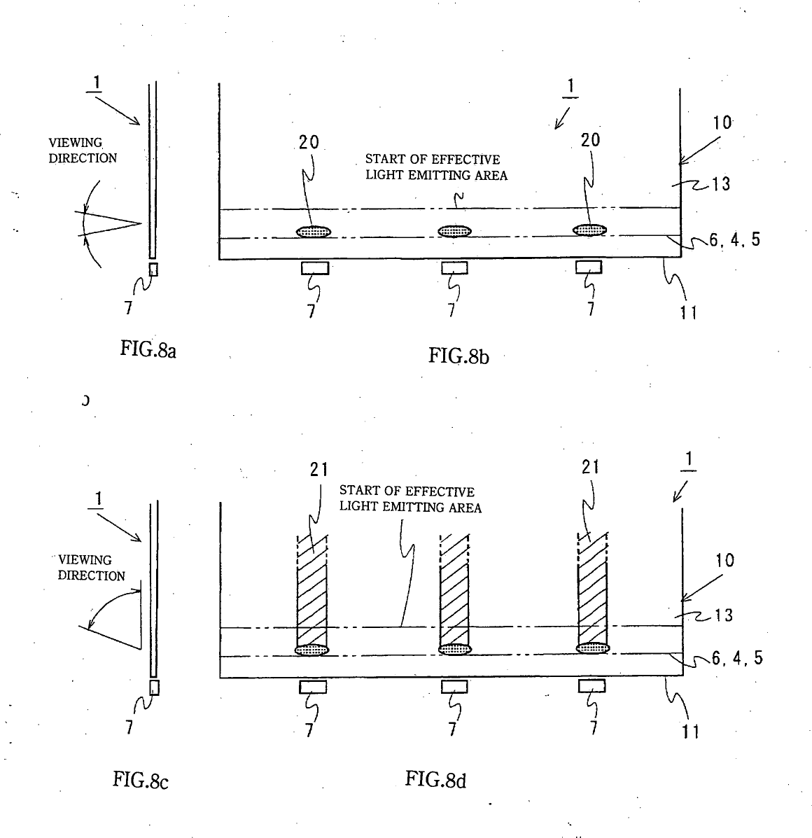

However, this direction is different from emission directions of light that entered into light guide plate 10 via incidence face 11 without passing upper or lower edge 17, 18, resulting in an emphasized bright part 20 (See FIG. 8).

In other words, if such a prior art is employed, light H1, H2 entering into light guide plate 10 through other than incidence face 11 looks not only like ellipse-shaped bright part 20 when viewed from the normal direction of emission face 13 as shown in FIGS. 8a, 8b, but also like ellipse-shaped bright part 20 and band-shaped bright region 21 when viewed from a direction inclined with respect to the normal direction of emission face 13 as shown in FIGS. 8c, 8d.

Such

To the contrary, surface light source device 1 of the embodiment can reduce light which is emitted from a region where bright part 20 and band-shaped bright region 21 are especially apt to appear. Therefore, not only bright part 20 is relaxed effectively and made less conspicuous but also band-like bright region 21 is prevented from appearing (See FIG. 6). Thus the embodiment can provide a uniformalized emission brightness, and a high-quality illumination and image display. In addition, utilizable area (effective light emitting area and light utilization efficiency are increased because bright part 20 and band-like bright region 21 can be suppressed.

According to this embodiment LEDs 7 and light guide plate 10 are mounted on frame 9 formed of a low light reflectivity member which is exposed in a part where reflection sheet 12 dose not extends. However, this does not the scope of the present invention.

For example, light shielding member 29 may be intentionally disposed opposite to back face 14 at least in a range where reflection sheet 12 does not exist, as shown in FIG. 10. This an increased quantity of light is absorbed by light shielding member 29, thereby preventing more effectively bright part 20 and band-like bright region from appearing.

Light shielding member 29 is, for example, a sheet-like member made of PET (black-coloured), being provided with an inner surface which is directed to back face, 14 and has a higher light absorb-ability as compared with that of the inner surface of frame 9.

Alternatively, black or grey paint, or tape having light shielding power may be applied to the inner surface (opposite to back face 14) of frame 9, instead of employing light shielding member 29.

It is noted that, if light shielding member is employed quantity of light that escapes from light guide plate 10 through back face 14 and then returns into light guide plate 10 in a range within predetermined distance L depends on the light reflectivity of the inner surface of light shielding member 29 and does not depend on light reflectivity of the inner surface of fame 9. This makes particular consideration on light reflectivity of frame material unnecessary. For example, light reflectivity of the material forming fame 9 may that of the material forming reflection sheet 12.

In addition, since light that escapes through back face 14 in a range between incidence face 11 and top 12a of reflection sheet 12 is not reflected by reflection sheet 12, this light can be utilized for illuminating another member. For example, a display member (not shown) other that LCD panel 3 may be disposed on the back side (on the side far from light guide plate 10) and illuminated ny the above light. This does not spoil function of preventing bright part 20 and band-like bright region 21 which would reduce illumination quality.

### Second Embodiment

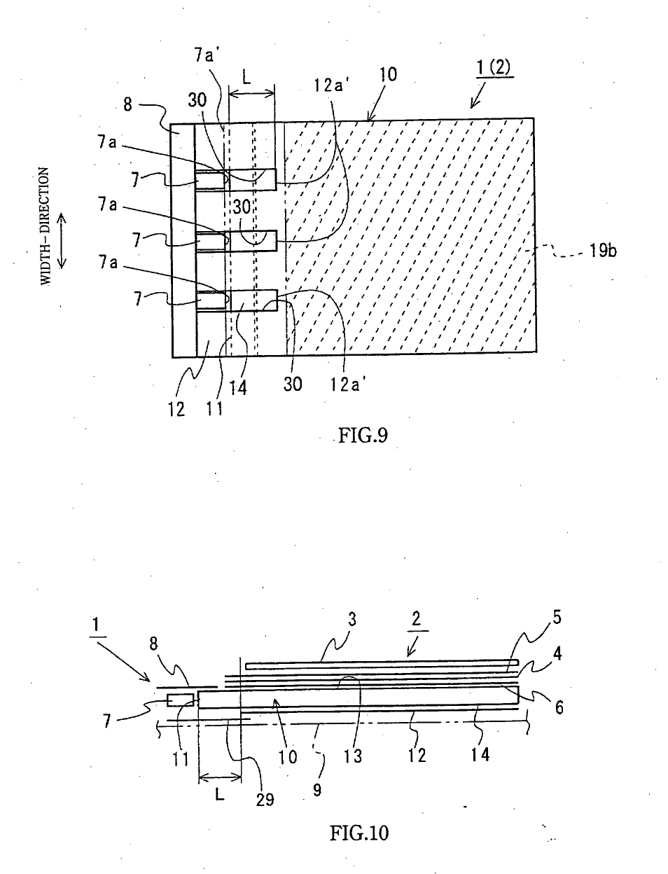

FIG. 9 shows the second embodiment of the present invention. Surface light source 1 and display 2 comprising the same in accordance with this embodiment have the same basic structure as that of surface light source 1 and display 2 in accordance with the above-described first embodiment except for a partial difference.

According to the partial difference, this embodiment exclusively defines a range where reflection sheet 12 is absent so that the range exists only in a region corresponds to width of emitting portion of each LED.

That is, reflection sheet 12 disposed along back face 14 in this embodiment has rectangle-like cuts 30. According to the forementioned definition, a part of back face 14 opposite to cuts 30 belongs to “second area”.

Number of cut(s) is one or more depending on that of LED(s) 7 disposed. Width of each cut 30 is approximately the same as that of light emitting portion of each LED 7. Position of each cut 30 corresponds to that of each LED 7. The most secluded portions. 12a” of cuts 30 are distant from incidence face 11 by predetermined distance L. Positions of the most secluded portions 12a correspond to the position of top 12a (near to LEDs) of reflection sheet 12 employed in the above-described first embodiment.

Namely, its can said that reflection sheet 12 employed in this embodiment is provided by adding band-like elongation(s) at least reaching incidence face 11 to reflection sheet 12 employed in the first embodiment.

According to the forementioned definition, a part of back face 14 corresponding to the elongation(s) belongs to “first area”. The band-like elongation(s) are formed as to avoid a part corresponding to LED(s) 7.

As shown in FIG. 9, this embodiment employs elongations extending over incidence face 11, with the result elongations adjacent to each other sandwiches each LED 7. That is, each elongation extends away from an effective light emitting area over imaginary line 7a′ that corresponds to light emitting ace a of LD 7 and runs in parallel with incidence face 11.

According to this embodiment, light utilization efficiency is further increased without loosing merits like those of the first embodiment. The reason is as follows.

As described, with referring to FIG. 5a, bright part 20 or band-like bright region 21 is mainly caused by light H1, H2 that enters into light guide plate 10 via vicinages of upper/lower edges 17, 18 of incidence face 11.

It is noted that light H1, H2 does not exist all over the width along incidence face, but mainly exists at positions corresponding to each LED 7. In other words, light H1, H2 is almost absent in the other portions (in a range corresponding to no LED 7).

Considering this, this embodiment employs reflection sheet 12 having cuts 30 each of which corresponds to the positions (range) where light H1, H2 mainly exists.

Elongations (absence of cut 30) of reflection sheet 12 are formed as to correspond to the positions (range) where light H1, H2 is almost absent.

Therefore, even if light H1, H2 leaks through back face 12, the leaking light is not reflected by the inner surface of reflection sheet 12, but reflected only by the inner surface of frame 9. As described previously, reflection at the inner surface of frame 9 is weak, with the result that bright part 20 and band-like bright region 21 are prevented from appearing in generally the same way as the first embodiment.

On the other hand, at the positions (range) where light H1, H2 is almost absent, leaking light from back face 14 is reflected by the inner surface of elongations of reflection sheet 12, being returned into light guide plate 10. However, this light hardly originates from light H1, H2, scarcely causing bright part 20 and band-like bright region 21 to appear.

However, quantity of light returning into light guide plate 10 is somewhat increased due to reflection at the inner surface of the elongations of reflection sheet 12 as compared with the first embodiment. As a result, light utilization efficiency is more improved.

In addition, although light might tend to fail to reach positions (range) corresponding vicinages of incidence face 11 and absence of LED 7, the elongations of reflection sheet 12 employed in this embodiment weaken this tendency.

According to this embodiment, frame 9 as a low light reflectivity member is exposed in a part corresponding to cuts 30. However, this does not the scope of the present invention.

For example, light shielding member 29 as described above may be arranged at cuts 30 so that light absorption coefficient or light reflectivity is controlled as required (See FIG. 10).

### Modifications of Embodiments

According to the above-described embodiments, the inner surface (opposite to light guide plate 10) of driving circuit board (cover member) 8 is reflective. However, this does not the scope of the present invention. For example, the following modifications are allowed.

(1) Material having light shielding ability may be printed or adhesively-applied to the inner surface of driving circuit board (cover member) 8.

(2) Alternatively, a light shielding member may be interposed between the cover member and light guide plate 10.

(3) Light shielding print may be applied to an inner surface (opposite to emission face 13 of light guide plate 10) of an end portion near to LEDs 7 of light diffusion member 6.

(4) A light shielding member, not shown, may be disposed between the end portion near to LEDs 7 of light diffusion member 6 and light guide plate 10 in order to improve illumination quality and display quality by preventing light from leaking from a vicinage of incidence face 11 to the side of image display panel 3, double-adhesive-face tape having a black surface opposite to emission face 13 may be employed as a light shielding member.

What is claimed is:

1. A surface light source device comprising:
a primary light source consisting of at least one point-like light source;
a light guide plate 10 having a side face providing an incidence face to receive primary light from said primary light source and an emission face including effective light emitting area from which light is outputted as illumination light, and a back face opposite to said emission face; and
a reflection member which is provided with a reflection face hang a high light reflectivity and is disposed so that said reflection face is directed to said back face, wherein
said back face includes a first area opposite to which said reflection member is disposed and a second area opposite to which said reflection member is not disposed, and further
said back face provides, at least at a location corresponding to a disposal location of said primary light source and within a range of a first predetermined distance from said incidence face, a region belonging to said second area.

2. A surface light source device in accordance with claim 1, wherein said first predetermined distance is generally equal to 2h·tan θ (where h is thickness of said light guide plate at said incidence face and angle θ is critical angle at an interface between said light guide plate and air).

3. A surface light source device in accordance with claim 1 or 2, wherein said back face does not include, within said range of said first predetermined distance, any part belonging to said first area.

4. A surface light source device in accordance with claim 1 or 2, wherein said back face includes, within said range of said first predetermined distance, a first part belonging to said first area and a second part belonging to said second area, said second part being a part corresponding to said disposal location of said primary light source.

5. A surface light source device in accordance with claim 1 or 2, wherein said effective light emitting area extends only in a range exceeding a second predetermined distance from said incidence fare, said second predetermined distance is slightly larger than said first predetermined distance.

6. A surface light source device in accordance with claim 3, wherein said effective light emitting; area extends only in a range exceeding a second predetermined distance from said incidence face, said second predetermined distance is slightly larger than said first predetermined distance.

7. A surface light source device in accordance with claim 4, wherein said effective light emitting area extends only in a range exceeding a second predetermined distance from said incidence face, said second predetermined distance is slightly larger than said first predetermined distance.

8. A surface light source device in accordance with claim 4, wherein said reflection member is provided with at least one elongation which is elongated away from said incidence face over an imaginary line drawn by extending an light outgoing surface of said point-like light source in parallel with said incidence face.

9. A surface light source device in accordance with claim 7, wherein said reflection member is provided with at least one elongation which is elongated away from said incidence face over an imaginary line drawn by extending an light outgoing surface of said point-like light source in parallel with said incidence face.

10. A surface light source device in accordance with claim 1 or 2, wherein a member which has a surface light reflectivity of which is lower than that of said reflection face is disposed so that said surface is opposite to said second area of said back face.

11. A surface light source device in accordance with claim 3, wherein a member which has a surface light reflectivity of which is lower than that of said reflection face is disposed so that said surface is opposite to said second area of said back face.

12. A surface light source device in accordance with claim 4, wherein a member which has a surface light reflectivity of which is lower than that of said reflection face is disposed so that said surface is opposite to said second area of said back face.

13. A surface light source device in accordance with claim 5, wherein a member which has a surface light reflectivity of which is lower than that of said reflection face is disposed so that said surface is opposite to said second area of said back face.

14. A surface light source device in accordance with claim 6, wherein a member which has a surface light reflectivity of which is lower than that of said reflection face is disposed so that said surface is opposite to said second area of said back face.

15. A surface light source device in accordance with claim 7, wherein a member which has a surface light reflectivity of which is lower than that of said reflection face is disposed so that said surface is opposite to said second area of said back face.

16. A surface light source device in accordance with claim 8, wherein a member which has a surface light reflectivity of which is lower than that of said reflection face is disposed so that said surface is opposite to said second area of said back face.

17. A surface light source device in accordance with claim 9, wherein a member which has a surface light reflectivity of which is lower than that of said reflection face is disposed so that said surface is opposite to said second area of said back face.

18. A surface light source device in accordance with claim 1 or 2, wherein a light shielding member having a light absorptive surface is disposed so that said light absorptive surface is opposite to said second area of said back face.

19. A surface light source device in accordance with claim 3, wherein a light shielding member having a light absorptive surface is disposed so that said light absorptive surface is opposite to said second area of said back face.

20. A surface light source device in accordance with claim 4, wherein a light shielding member having a light absorptive surface is disposed so that said light absorptive surface is opposite to said second area of said back face.

21. A surface light source device in accordance with claim 5, wherein a light shielding member having a light absorptive surface is disposed so that said light absorptive surface is opposite to said second area of said back face.

22. A surface light source device in accordance with claim 6, wherein a light shielding member having a light absorptive surface is disposed so that said light absorptive surface is opposite to said second area of said back face.

23. A surface light source device in accordance with claim 7, wherein a light shielding member having a light absorptive surface is disposed so that said light absorptive surface is opposite to said second area of said back face.

24. A surface light source device in accordance with claim 8, wherein a light shielding member having a light absorptive surface is disposed so that said light absorptive surface is opposite to said second area of said back face.

25. A surface light source device in accordance with claim 9, wherein a light shielding member having a tight absorptive surface is disposed so that said light absorptive surface is opposite to said second area of said back face.

26. A display comprising:
a surface light source device; and
a display member illuminated by said A surface light source device, wherein said A surface light source device is in accordance with claim 1 or 2.

27. A display comprising:
a surface light source device; and
a display member illuminated by said A surface light source device, wherein said A surface light source device is in accordance with claim 3.

28. A display comprising:
a surface light source device; and
a display member illuminated by said A surface light source device, wherein said A surface light source device is in accordance with claim 4.

29. A display comprising:
a surface light source device; and
a display member illuminated by said A surface light source device, wherein said A surface light source device is in accordance with claim 5.

30. A display comprising:
a surface light source device; and
a display member illuminated by said A surface light source device, wherein said A surface light source device is in accordance with claim 6.

31. A display comprising:
a surface light source device; and
a display member illuminated by said A surface light source device, wherein said A surface light source device is in accordance with claim 7.

32. A display comprising:
a surface light source device; and
a display member illuminated by said A surface light source device, wherein said A surface light source device is in accordance with claim 8.

33. A display comprising:
a surface light source device; and
a display member illuminated by said A surface light source device, wherein said A surface light source device is in accordance with claim 9.

34. A display comprising:
a surface light source device; and
a display member illuminated by said A surface light source device, wherein said A surface light source device is in accordance with claim 10.

35. A display comprising:
a surface light source device; and
a display member illuminated by said A surface light source device, wherein said A surface light source device is in accordance with claim 11.

36. A display comprising:
a surface light source device; and
a display member illuminated by said A surface light source device, wherein said A surface light source device is in accordance with claim 12.

37. A display comprising:
a surface light source-device; and
a display member illuminated by said A surface light source device, wherein said A surface light source device is in accordance with claim 13.

38. A display comprising:
a surface light source device; and
a display member illuminated by said A surface light source device, wherein said A surface light source device is in accordance with claim 14.

39. A display comprising:
a surface light source device; and
a display member illuminated by said A surface light source device, wherein said A surface light source device is in accordance with claim 15.

40. A display comprising:
a surface light source device; and
a display member illuminated by said A surface light source device, wherein said A surface light source device is in accordance with claim 16.

41. A display comprising:
a surface light source device; and
a display member illuminated by said A surface light source device, wherein said A surface light source device is in accordance with claim 17.

42. A display comprising:
a surface light source device; and
a display member illuminated by said A surface light source device, wherein said A surface light source device is in accordance with claim 18.

43. A display comprising:
a surface light source device; and
a display member illuminated by said A surface light source device, wherein said A surface light source device is in accordance with claim 19.

44. A display comprising:
a surface light source device; and
a display member illuminated by said A surface light source device, wherein said A surface light source device is in accordance with claim 20.

45. A display comprising:
a surface light source device; and
a display member illuminated by said A surface light source device, wherein said A surface light source device is in accordance with claim 21.

45. A display comprising:
a surface light source device; and
a display member illuminated by said A surface light source device, wherein said A surface light source device is in accordance with claim 22.

46. A display comprising:
a surface light source device; and
a display member illuminated by said A surface light source device, wherein said A spice light source device is in accordance with claim 23.

47. A display comprising:
a surface light source device; and
a display member illuminated by said A surface light source device, wherein said A surface light source device is in accordance with claim 24.

48. A display comprising:
a surface light source device; and
a display member illuminated by said A surface light source device, wherein said A surface light source device is in accordance with claim 25.
